(19) United States
(12) Patent Application Publication
(10) Pub. No.: US 2023/0271567 A1
(43) Pub. Date: Aug. 31, 2023

(54) WIRING HARNESS ROUTING STRUCTURE, LINK TYPE SLIDING DOOR, AND WIRING HARNESS

(71) Applicants: Yazaki Corporation, Tokyo (JP); AISIN CORPORATION, Kariya (JP)

(72) Inventors: Naoto KOGURE, Shizuoka (JP); Hikaru SANO, Shizuoka (JP); Seiichi SUMIYA, Kariya (JP)

(73) Assignees: Yazaki Corporation, Tokyo (JP); AISIN CORPORATION, Kariya (JP)

(21) Appl. No.: 18/174,042

(22) Filed: Feb. 24, 2023

(30) Foreign Application Priority Data
Feb. 28, 2022 (JP) 2022-028837

(51) Int. Cl. B60R 16/02; E05D 15/32

(52) U.S. Cl. CPC B60R 16/0207; E05D 15/32; E05Y 2201/624; E05Y 2400/654; E05Y 2900/531

(57) ABSTRACT

In a wiring harness routing structure, a main link arm slidably supports a door body relative to a vehicle body, while rotationally moving relative to each of the vehicle body and the door body. A sub-link arm is provided on a lower side in a height direction of the main link arm, and slidably supports the door body relative to the vehicle body, together with the main link arm, while rotationally moving relative to each of the vehicle body and the door body. A routed line is routed and provided along the sub-link arm, and connects a vehicle-body-side connector and a door-side connector. In addition, the routed line is routed through a side closer to the main link arm of a first coupler that is provided in a sub-link mechanism.

### CROSS-REFERENCE TO RELATED APPLICATION(S)

The present application claims priority to and incorporates by reference the entire contents of Japanese Patent Application No. 2022-028837 filed in Japan on Feb. 28, 2022.

### BACKGROUND OF THE INVENTION

### 1. Field of the Invention

The present invention relates to a wiring harness routing structure, a link type sliding door, and a wiring harness.

### 2. Description of the Related Art

Conventionally, for example, JP 2019-134626 A describes a routing structure for a sliding door. This routing structure for the sliding door includes a sliding door that includes a sliding unit that is guided by a guiding unit provided on a vehicle body side, a flexible conductor that electrically connects the sliding door to the vehicle body side, and crosses a trajectory space that the sliding unit passes through, and a plate-shaped elastic body that is disposed along the conductor.

Meanwhile, in a case where, as a configuration of the sliding door, the sliding unit is not included, and a link type sliding door that includes two link arms that slidably support the sliding door relative to a vehicle body is configured, for example, it is desired that a routed line be routed between the vehicle body and the sliding body in a state where the sliding door is stably supported by each of the link arms.

### SUMMARY OF THE INVENTION

Accordingly, the present invention has been made in view of the above, and it is an object of the present invention to provide a wiring harness routing structure, a link type sliding door, and a wiring harness that enable a routed line to be properly routed.

In order to solve the above mentioned problem and achieve the object, a wiring harness routing structure according to one aspect of the present invention includes a first link arm that includes one end that is rotatably coupled to a vehicle body by using a first vehicle-body-side coupler, and another end that is rotatably coupled to a door body by using a first door-side coupler, the first link arm slidably supporting the door body relative to the vehicle body, while rotationally moving relative to each of the vehicle body and the door body; a second link arm that is provided on a lower side in a vertical direction of the first link arm, and includes one end that is rotatably coupled to the vehicle body by using a second vehicle-body-side coupler, and another end that is rotatably coupled to the door body by using a second door-side coupler, the second link arm, together with the first link arm, slidably supporting the door body relative to the vehicle body, while rotationally moving relative to each of the vehicle body and the door body; and a routed line that is routed and provided along the second link arm, and connects a connection target on a side of the vehicle body and a connection target on a side of the door body, wherein the routed line is routed through a side closer to the first link arm of the second vehicle-body-side coupler.

In order to achieve the object, a link type sliding door according to another aspect of the present invention includes a door body that is mounted on a vehicle body; a first link arm that includes one end that is rotatably coupled to the vehicle body by using a first vehicle-body-side coupler, and another end that is rotatably coupled to the door body by using a first door-side coupler, the first link arm slidably supporting the door body relative to the vehicle body, while rotationally moving relative to each of the vehicle body and the door body; a second link arm that is provided on a lower side in a vertical direction of the first link arm, and includes one end that is rotatably coupled to the vehicle body by using a second vehicle-body-side coupler, and another end that is rotatably coupled to the door body by using a second door-side coupler, the second link arm, together with the first link arm, slidably supporting the door body relative to the vehicle body, while rotationally moving relative to each of the vehicle body and the door body; and a routed line that is routed and provided along the second link arm, and connects a connection target on a side of the vehicle body and a connection target on a side of the door body, wherein the routed line is routed through a side closer to the first link arm of the second vehicle-body-side coupler.

In order to achieve the object, a wiring harness according to still another aspect of the present invention includes a routed line that is routed and provided along a second link arm, and connects a connection target on a side of a vehicle body and a connection target on a side of a door body, the second link arm being provided on a lower side in a vertical direction of a first link arm, and including one end that is rotatably coupled to the vehicle body by using a second vehicle-body-side coupler, and another end that is rotatably coupled to the door body by using a second door-side coupler, the second link arm, together with the first link arm, slidably supporting the door body relative to the vehicle body, while rotationally moving relative to each of the vehicle body and the door body, the first link arm including one end that is rotatably coupled to the vehicle body by using a first vehicle-body-side coupler, and another end that is rotatably coupled to the door body by using a first door-side coupler, the first link arm slidably supporting the door body relative to the vehicle body, while rotationally moving relative to each of the vehicle body and the door body, wherein the routed line is routed through a side closer to the first link arm of the second vehicle-body-side coupler.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a configuration example of a wiring harness routing structure according to an embodiment;

FIG. 2 is an exploded perspective view illustrating a configuration example of the wiring harness routing structure according to the embodiment;

FIG. 3 is a perspective view illustrating a configuration example of a main link mechanism according to the embodiment;

FIG. 4 is a perspective view illustrating a configuration example of a sub-link mechanism according to the embodiment; and

FIG. 5 is a front view illustrating a configuration example of the wiring harness routing structure according to the embodiment.

### DETAILED DESCRIPTION OF THE PREFERRED EMBODIMENTS

A preferred embodiment (an embodiment) of the present invention is described in detail with reference to the drawings. The content described in the embodiment described below is not restrictive of the present invention. Furthermore, the components described below include components that those skilled in the art could easily conceive of, or substantially the same components. Moreover, the configurations described below can be appropriately combined. Furthermore, various omissions, replacements, or modifications can be made to the configurations without departing from the spirit of the present invention.

### Embodiment

A wiring harness routing structure 1, a link type sliding door SD, and a wiring harness WH according to the embodiment are described with reference to the drawings.

Note that in the description below, from among a first direction, a second direction, and a third direction that cross each other, the first direction is referred to as an “extending direction X”, the second direction is referred to as a “width direction Y”, and the third direction is referred to as a “height direction Z (crossing direction Z). The extending direction X, the width direction Y, and the height direction Z cross each other, and are typically orthogonal to each other. The extending direction X is, for example, a direction along a direction (a longer-side direction) in which a main link arm 11 described later extends. The width direction Y is, for example, a direction along a shorter-side direction of the main link arm 11. The height direction Z is a direction along a vehicle height direction (a car height direction) of a vehicle, and is also a direction along a vertical direction. A sliding direction S of a door body D is a direction along the extending direction X of the main link arm 11 in a state where the door body D is closed, and here, the sliding direction S corresponds to a direction along a direction of a total length of a vehicle body B. In other words, the sliding direction S of the door body D is a direction that crosses a rotational movement axis (a rotational movement shafts 121 and 131 described later) of the main link arm 11, and is typically a direction that is orthogonal to the rotational movement axis. Respective directions to be used in the description below indicate directions in a state where respective units have been mounted on each other, unless otherwise specified.

The wiring harness routing structure 1 is applied to a vehicle, slidably supports the door body D relative to the vehicle body B of the vehicle, and electrically connects a connection target, such as a device or a connector, that is provided on a side of the vehicle body B to a connection target, such as a device or a connector, that is provided on a side of the door body D. In this example, on the side of the vehicle body B, a vehicle-body-side connector BC serving as the connection target on the side of the vehicle body B is provided. On the side of the door body D, a door-side connector DC serving as the connection target on a door side is provided. The vehicle-body-side connector BC is provided closer to the sub-link mechanism 20 described later than a main link mechanism 10 described later, and in this example, the vehicle-body-side connector BC is provided on an upper side in the height direction Z of the sub-link mechanism 20. In other words, the vehicle-body-side connector BC is provided on a side closer to the main link mechanism 10 of the sub-link mechanism 20. The door-side connector DC is provided between the main link mechanism 10 and the sub-link mechanism 20 (in this example, in a roughly intermediate position between the main link mechanism 10 and the sub-link mechanism 20 in the height direction Z).

Here, the vehicle body B includes a vehicle body frame Bb, a first projecting support Bb1, and a second projecting support Bb2 in addition to the vehicle-body-side connector BC described above. The vehicle body frame Bb forms a framework of the vehicle body B, and supports, for example, an engine, a transmission, suspension, wheels, or the like. The first projecting support Bb1 is provided on the vehicle body frame Bb that is located near a doorway Ba that is opened or closed by using the door body D, and is formed to project from the vehicle body frame Bb to a vehicle cabin side. The first projecting support Bb1 is formed in a frame shape, for example, by bending a metal flat plate, and internally holds a first coupler 12 of the main link mechanism 10 described later to support the first coupler 12. Furthermore, the second projecting support Bb2 is provided to be aligned with the first projecting support Bb1 along the height direction Z, is located on a lower side in the height direction Z of the first projecting support Bb1, and is formed to project from the vehicle body frame Bb to the vehicle cabin side. The second projecting support Bb2 is formed in a frame shape, for example, by bending a metal flat plate, and internally holds a first coupler 22 of the sub-link mechanism 20 described later to support the first coupler 22. On an upper side in the height direction Z of the second projecting support Bb2, the vehicle-body-side connector BC is provided.

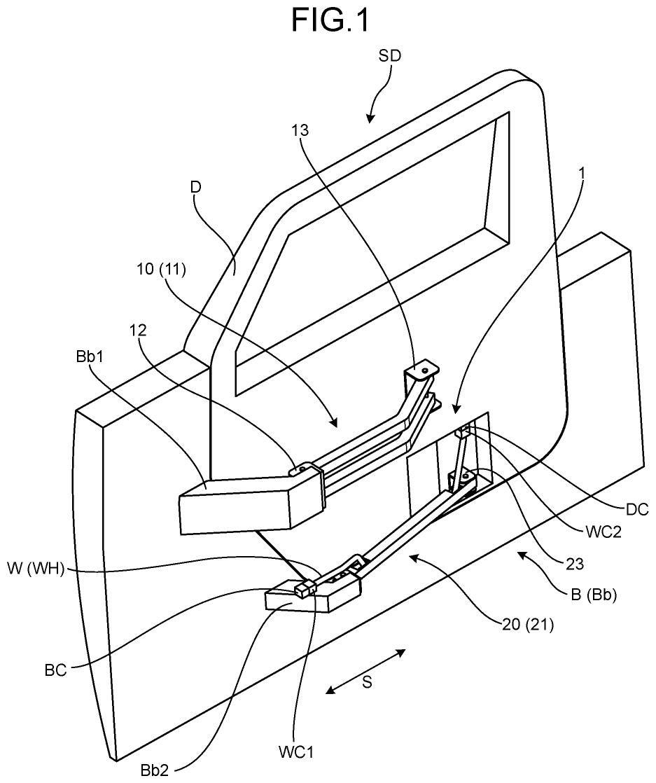

The wiring harness routing structure 1 includes the main link mechanism 10, the sub-link mechanism 20, and a routed line W, as illustrated in FIGS. 1 to 4. The routed line W configures the wiring harness WH. In other words, it can also be said that the wiring harness WH includes the routed line W. Furthermore, the door body D, the main link mechanism 10, the sub-link mechanism 20, and the routed line W configure the link type sliding door SD. In other words, it can also be said that the link type sliding door SD includes the door body D, the main link mechanism 10, the sub-link mechanism 20, and the routed line W.

Here, the wiring harness routing structure 1 supports the door body D by using the main link mechanism 10 and the sub-link mechanism 20, and rotationally moves the main link arm 11 and a sub-link arm 21 that are described later to slide the door body D relative to the vehicle body B along the sliding direction S, without using a general guiding rail for sliding. The door body D is mounted on the vehicle body B, for example, as a door for a rear seat, and slides along the sliding direction S from a fully closed position to a fully open position relative to the vehicle body B to open the doorway Ba through which an occupant gets in or out of the vehicle. On the other hand, the door body D slides along the sliding direction S from the fully open position to the fully closed position relative to vehicle body B to close the doorway Ba. The wiring harness routing structure 1 is described in detail below.

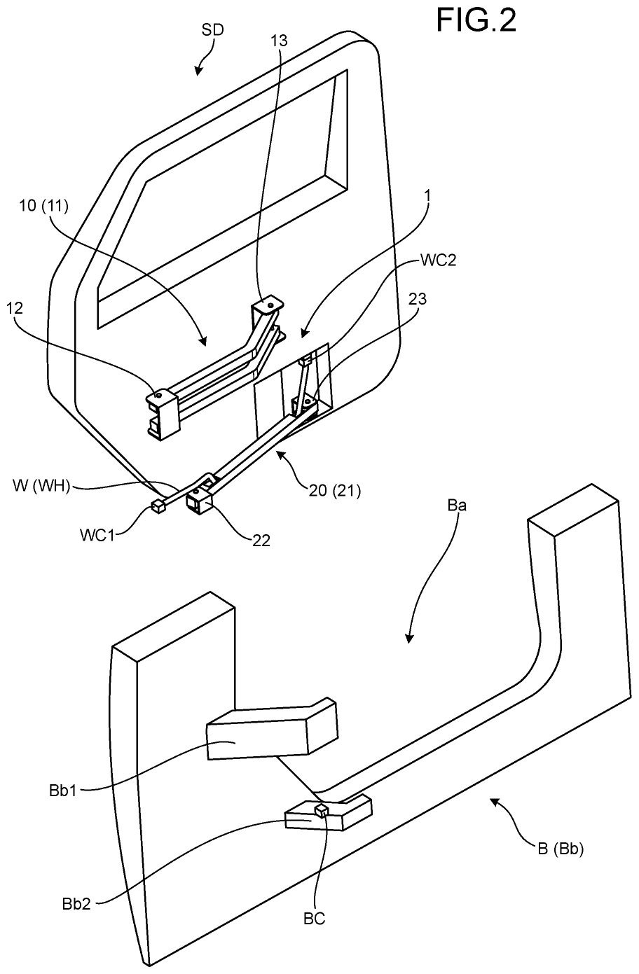

The main link mechanism 10 is a mechanism that slidably supports the door body D relative to the vehicle body B, together with the sub-link mechanism 20, as illustrated in FIGS. 1 and 2. The main link mechanism 10 includes the main link arm 11, the first coupler 12, and a second coupler 13.

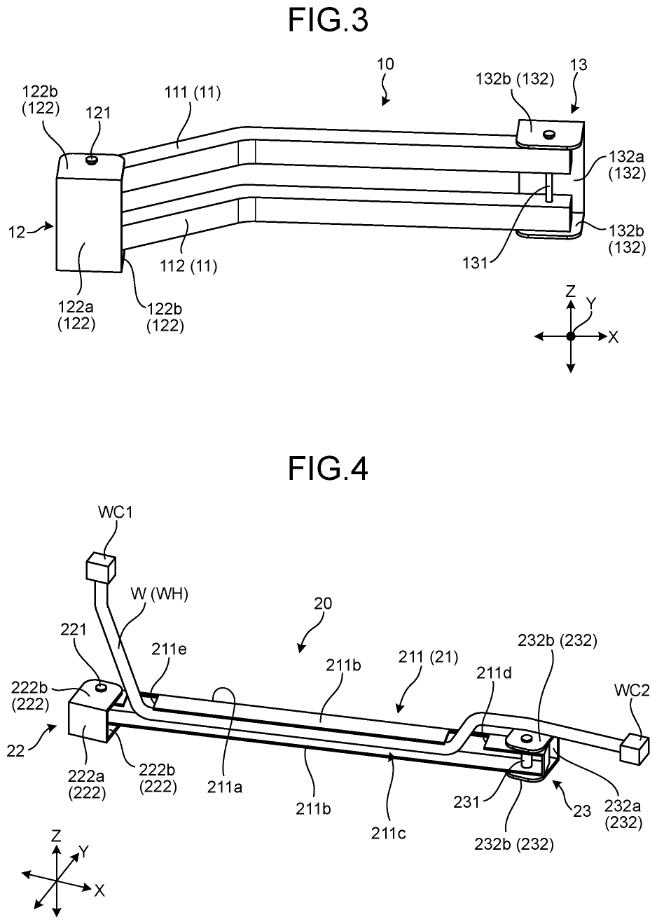

The main link arm 11 is a member that slidably supports the door body D relative to the vehicle body B. The main link arm 11 includes a first arm 111 and a second arm 112, as illustrated in FIG. 3.

The first arm 111 is a metal member that extends along the extending direction X, and is formed in an elongated shape. The first arm 111 is formed, for example, in a shape including a bent portion that is bent from a side of the vehicle body B to a side of the door body D. Note that the first arm 111 is not limited to such a bent shape if the door body D can be slidably supported relative to the vehicle body B. The first arm 111 is formed in a pole shape, and is formed in a square pole shape in this example. The first arm 111 is formed in the pole shape, and therefore the first arm 111 can firmly support the door body D in comparison with, for example, a case where the first arm 111 is formed in a tube shape.

The second arm 112 is configured similarly to the first arm 111 described above. Stated another way, the second arm 112 is a metal member that extends along the extending direction X, and is formed in an elongated shape. The second arm 112 is formed, for example, in a shape including a bent portion that is bent from a side of the vehicle body B to a side of the door body D. Note that the second arm 112 is not limited to such a bent shape if the door body D can be slidably supported relative to the vehicle body B. The second arm 112 is disposed to be aligned with the first arm 111 along the height direction Z. The second arm 112 is formed in a pole shape, and is formed in a square pole shape in this example. The second arm 112 is formed in the pole shape, and therefore the second arm 112 can firmly support the door body D in comparison with, for example, a case where the second arm 112 is formed in a tube shape.

Next, the first coupler 12 is described. As illustrated in FIG. 2, the first coupler 12 rotatably couples one end in the extending direction X of the main link arm 11 to the first projecting support Bb1 of the vehicle body B, and includes the rotational movement shaft 121 and a bearing 122.

The rotational movement shaft 121 rotatably supports the one end in the extending direction X of the main link arm 11. The rotational movement shaft 121 is formed in a bar shape, extends along the height direction Z, and is inserted into a hole (a hole having a tube shape) at the one end in the extending direction X of the main link arm 11. Specifically, the rotational movement shaft 121 is inserted into a hole at one end in the extending direction X of the first arm 111, and a hole at one end in the extending direction X of the second arm 112 in the main link arm 11. The rotational movement shaft 121 is provided with a stopper (not illustrated) that keeps a spacing between the first arm 111 and the second arm 112 constant in the height direction Z. This stopper prevents the first arm 111 and the second arm 112 from being misaligned in the height direction Z. The rotational movement shaft 121 that extends along the height direction Z supports the one end of the first arm 111 and the one end of the second arm 112 in a rotatable manner around an axis of the rotational movement shaft 121. Note that a configuration that prevents the first arm 111 and the second arm 112 from being misaligned may be a configuration other than the stopper described above.

The bearing 122 couples the rotational movement shaft 121 to the vehicle body B. The bearing 122 includes a fixed plate 122a and a pair of support plates 122b.

The fixed plate 122a is a portion that is fixed to the first projecting support Bb1 of the vehicle body B. The fixed plate 122a is formed in a flat plate shape, extends along the height direction Z, and is fixed to an inside of the first projecting support Bb1 of the vehicle body B that is formed in a frame shape.

The pair of support plates 122b support the rotational movement shaft 121. The pair of support plates 122b are each formed in a flat plate shape, are provided in a standing manner along the width direction Y from both ends in the height direction Z of the fixed plate 122a, and are spaced apart from each other by a fixed spacing along the height direction Z. The pair of support plates 122b are provided with the rotational movement shaft 121 between one support plate 122b and another support plate 122b. The pair of support plates 122b each include a hole that the rotational movement shaft 121 is inserted into, one end of the rotational movement shaft 121 is inserted into the hole of one support plate 122b, and another end of the rotational movement shaft 121 is inserted into the hole of another support plate 122b. The rotational movement shaft 121 that has been inserted into the pair of support plates 122b is provided with a slip-off prevention portion in both end portions of the rotational movement shaft 121. In the bearing 122 configured as described above, the fixed plate 122a is fixed to the first projecting support Bb1 of the vehicle body B in a state where both ends of the rotational movement shaft 121 that has been inserted into the first arm 111 and the second arm 112 are supported by the pair of support plates 122b.

Next, the second coupler 13 is described. As illustrated in FIG. 3, the second coupler 13 rotatably couples another end in the extending direction X of the main link arm 11 to the door body D, and is configured similarly to the first coupler 12. Stated another way, the second coupler 13 includes a rotational movement shaft 131 and a bearing 132.

The rotational movement shaft 131 rotatably supports the other end in the extending direction X of the main link arm 11. The rotational movement shaft 131 is formed in a bar shape, extends along the height direction Z, and is inserted into a hole (a hole having a tube shape) at the other end in the extending direction X of the main link arm 11. Specifically, the rotational movement shaft 131 is inserted into a hole at another end in the extending direction X of the first arm 111, and a hole at another end in the extending direction X of the second arm 112 in the main link arm 11. The rotational movement shaft 131 is provided with a stopper (not illustrated) that keeps a spacing between the first arm 111 and the second arm 112 constant in the height direction Z. This stopper prevents the first arm 111 and the second arm 112 from being misaligned in the height direction Z. The rotational movement shaft 131 that extends along the height direction Z supports the other end of the first arm 111 and the other end of the second arm 112 in a rotatable manner around an axis of the rotational movement shaft 131. Note that a configuration that prevents the first arm 111 and the second arm 112 from being misaligned may be a configuration other than the stopper described above.

The bearing 132 couples the rotational movement shaft 131 to the door body D. The bearing 132 includes a fixed plate 132a and a pair of support plates 132b.

The fixed plate 132a is a portion that is fixed to the door body D. The fixed plate 132a is formed in a flat plate shape, extends along the height direction Z, and is fixed to the door body D.

The pair of support plates 132b support the rotational movement shaft 131. The pair of support plates 132b are each formed in a flat plate shape, are provided in a standing manner along the width direction Y from both ends in the height direction Z of the fixed plate 132a, and are spaced apart from each other by a fixed spacing along the height direction Z. The pair of support plates 132b are provided with the rotational movement shaft 131 between one support plate 132b and another support plate 132b. The pair of support plates 132b each include a hole that the rotational movement shaft 131 is inserted into, one end of the rotational movement shaft 131 is inserted into the hole of one support plate 132b, and another end of the rotational movement shaft 131 is inserted into the hole of another support plate 132b. The rotational movement shaft 131 that has been inserted into the pair of support plates 132b is provided with a slip-off prevention portion in both end portions of the rotational movement shaft 131. In the bearing 132 configured as described above, the fixed plate 132a is fixed to the door body D in a state where both ends of the rotational movement shaft 131 that has been inserted into the first arm 111 and the second arm 112 are supported by the pair of support plates 132b.

The main link arm 11 configured as described above, together with the sub-link mechanism 20, supports the door body D relative to the vehicle body B in a slidable manner along the sliding direction S, while rotationally moving relative to each of the vehicle body B and the door body D.

Next, the sub-link mechanism 20 is described. The sub-link mechanism 20 is provided to be aligned with the main link mechanism 10 along the height direction Z, is provided on a lower side in the height direction Z of the main link mechanism 10 in this example, and slidably supports the door body D relative to the vehicle body B, together with the main link mechanism 10. The sub-link mechanism 20 includes the sub-link arm 21, the first coupler 22, and a second coupler 23.

The sub-link arm 21 is provided to be aligned with the main link arm 11 along the height direction Z, and includes a first arm 211, as illustrated in FIG. 4.

The first arm 211 is a metal member that extends along the extending direction X, and is formed in an elongated shape. The first arm 211 is formed, for example, in a linear shape along the extending direction X. Note that the first arm 211 is not limited to such a linear shape if the door body D can be slidably supported relative to the vehicle body B. The first arm 211 includes a bottom face 211a and a pair of side walls 211b. The bottom face 211a is a portion that is located on one side (a side opposite to the door body D) in the width direction Y, and is formed in an elongated shape and a flat plate shape along the extending direction X. The pair of side walls 211b are each formed in an elongated shape and a flat plate shape along the extending direction X, are provided in a standing manner along the width direction Y from both ends in the height direction Z of the bottom face 211a, and are spaced apart from each other by a fixed spacing along the height direction Z. The first arm 211 is open on another side (a side of the door body D) in the width direction Y of the bottom face 211a, and is closed in both end portions in the extending direction X. The first arm 211 houses the routed line W that is routed between a side of the vehicle body B and a side of the door body D, in a groove 211c described later that is formed to be surrounded by the bottom face 211a and the pair of side walls 211b.

Here, from among the pair of side walls 211b, the side wall 211b on one side (the side wall 211b on a side closer to the main link arm 11) includes a first cut-away portion 211d and a second cut-away portion 211e. The first cut-away portion 211d is provided on one side in the extending direction X of the side wall 211b, and is formed by cutting away part of the side wall 211b in a rectangular shape. The first cut-away portion 211d is an opening that guides a one end side of the routed line W that is housed in the groove 211c to an outside of the groove 211c. In the routed line W that is housed in the groove 211c, one end of the routed line W extends from an inside of the groove 211c to the outside via the first cut-away portion 211d, and is connected to the vehicle-body-side connector BC. Furthermore, the second cut-away portion 211e is provided on another side in the extending direction X of the side wall 211b, and is formed by cutting away part of the side wall 211b in a rectangular shape. The second cut-away portion 211e is an opening that guides another end side of the routed line W that is housed in the groove 211c to the outside of the groove 211c. In the routed line W that is housed in the groove 211c, another end of the routed line W extends from an inside of the groove 211c to the outside via the second cut-away portion 211e, and is connected to the door-side connector DC.

Next, the first coupler 22 is described. As illustrated in FIG. 4, the first coupler 22 rotatably couples one end in the extending direction X of the sub-link arm 21 to the vehicle body B, and includes a rotational movement shaft 221 and a bearing 222.

The rotational movement shaft 221 rotatably supports the one end in the extending direction X of the sub-link arm 21. The rotational movement shaft 221 is formed in a bar shape, extends along the height direction Z, and is inserted into a hole (a hole having a tube shape) at the one end in the extending direction X of the sub-link arm 21. Specifically, the rotational movement shaft 221 is inserted into a hole at one end in the extending direction X of the first arm 211 in the sub-link arm 21. The rotational movement shaft 221 that extends along the height direction Z supports the one end of the first arm 211 in a rotatable manner around an axis of the rotational movement shaft 221.

The bearing 222 couples the rotational movement shaft 221 to the vehicle body B. The bearing 222 includes a fixed plate 222a and a pair of support plates 222b.

The fixed plate 222a is a portion that is fixed to the second projecting support Bb2 of the vehicle body B. The fixed plate 222a is formed in a flat plate shape, extends along the height direction Z, and is fixed to an inside of the second projecting support Bb2 of the vehicle body B that is formed in a frame shape.

The pair of support plates 222b support the rotational movement shaft 221. The pair of support plates 222b are each formed in a flat plate shape, are provided in a standing manner along the width direction Y from both ends in the height direction Z of the fixed plate 222a, and are spaced apart from each other by a fixed spacing along the height direction Z. The pair of support plates 222b are provided with the rotational movement shaft 221 between one support plate 222b and another support plate 222b. The pair of support plates 222b each include a hole that the rotational movement shaft 221 is inserted into, one end of the rotational movement shaft 221 is inserted into the hole of one support plate 222b, and another end of the rotational movement shaft 221 is inserted into the hole of another support plate 222b. The rotational movement shaft 221 that has been inserted into the pair of support plates 222b is provided with a slip-off prevention portion in both end portions of the rotational movement shaft 221. In the bearing 222 configured as described above, the fixed plate 222a is fixed to the second projecting support Bb2 of the vehicle body B in a state where both ends of the rotational movement shaft 221 that has been inserted into the first arm 211 are supported by the pair of support plates 222b.

Next, the second coupler 23 is described. As illustrated in FIG. 4, the second coupler 23 rotatably couples another end in the extending direction X of the sub-link arm 21 to the door body D, and is configured similarly to the first coupler 22. Stated another way, the second coupler 23 includes a rotational movement shaft 231 and a bearing 232.

The rotational movement shaft 231 rotatably supports the other end in the extending direction X of the sub-link arm 21. The rotational movement shaft 231 is formed in a bar shape, extends along the height direction Z, and is inserted into a hole (a hole having a tube shape) at the other end in the extending direction X of the sub-link arm 21. Specifically, the rotational movement shaft 231 is inserted into a hole at another end in the extending direction X of the first arm 211 in the sub-link arm 21. The rotational movement shaft 231 that extends along the height direction Z supports the other end of the first arm 211 in a rotatable manner around an axis of the rotational movement shaft 231.

The bearing 232 couples the rotational movement shaft 231 to the door body D. The bearing 232 includes a fixed plate 232a and a pair of support plates 232b.

The fixed plate 232a is a portion that is fixed to the door body D. The fixed plate 232a is formed in a flat plate shape, extends along the height direction Z, and is fixed to the door body D.

The pair of support plates 232b support the rotational movement shaft 231. The pair of support plates 232b are each formed in a flat plate shape, are provided in a standing manner along the width direction Y from both ends in the height direction Z of the fixed plate 232a, and are spaced apart from each other by a fixed spacing along the height direction Z. The pair of support plates 232b are provided with the rotational movement shaft 231 between one support plate 232b and another support plate 232b. The pair of support plates 232b each include a hole that the rotational movement shaft 231 is inserted into, one end of the rotational movement shaft 231 is inserted into the hole of one support plate 232b, and another end of the rotational movement shaft 231 is inserted into the hole of another support plate 232b. The rotational movement shaft 231 that has been inserted into the pair of support plates 232b is provided with a slip-off prevention portion in both end portions of the rotational movement shaft 231. In the bearing 232 configured as described above, the fixed plate 232a is fixed to the door body D in a state where both ends of the rotational movement shaft 231 that has been inserted into the first arm 211 are supported by the pair of support plates 232b.

The sub-link arm 21 configured as described above, together with the main link arm 11, slidably supports the door body D relative to the vehicle body B, while rotationally moving relative to each of the vehicle body B and the door body D.

The wiring harness routing structure 1 includes the groove 211c that is provided in the sub-link arm 21, as a structure that routes the routed line W in the link type sliding door SD, as described above.

The groove 211c is provided in the first arm 211 of the sub-link arm 21, and is a region that is formed to be surrounded by the bottom face 211a and the pair of side walls 211b of the first arm 211. The groove 211c is formed in a groove shape along the extending direction X in the first arm 211, and a cross section of the groove 211c is formed in a rectangular shape. The groove 211c includes a housing space that can house the routed line W, can house, in the housing space, the routed line W that is routed along the first arm 211 between a side of the vehicle body B and a side of the door body D, and houses the routed line W in the housing space.

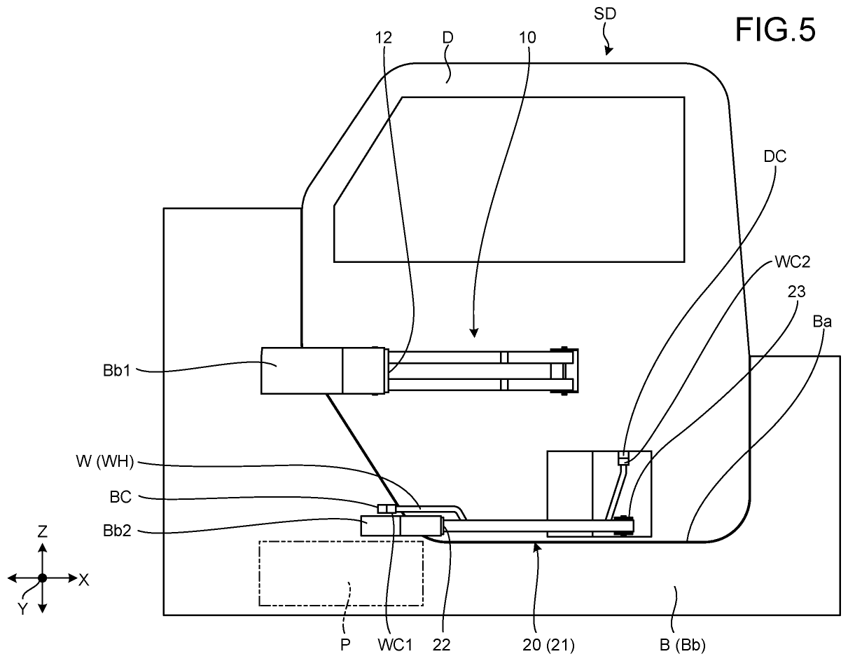

Next, the routed line W that is routed along the sub-link arm 21 is described. The routed line W includes a power line that is used to supply power, a communication line that is used to perform communication, or the like, is provided with a connector WC1 at one end, and is provided with a connector WC2 at another end. The routed line W is routed and provided along the sub-link arm 21, and in this example, the routed line W is routed in a state where the routed line W is housed in the groove 211c of the sub-link arm 21. In the routed line W that is housed in the groove 211c, one end of the routed line W extends from an inside of the groove 211c to an outside (a side of the vehicle-body-side connector BC) via the first cut-away portion 211d, and another end of the routed line W extends from the inside of the groove 211c to the outside (a side of the door-side connector DC) via the second cut-away portion 211e. In addition, the routed line W that extends to a side of the vehicle-body-side connector BC is routed through a side closer to the main link arm 11 of the first coupler 22 that is coupled to one end of the sub-link arm 21, and is also routed through a side closer to the main link arm 11 of the second projecting support Bb2 that supports the first coupler 22, as illustrated in FIGS. 4 and 5. In other words, the routed line W is routed through an upper side in the height direction Z of the first coupler 22 that is coupled to one end of the sub-link arm 21, and is also routed thought an upper side in the height direction Z of the second projecting support Bb2 that supports the first coupler 22. Furthermore, the routed line W that extends to a side of the door-side connector DC is routed through a side closer to the main link arm 11 of the second coupler 23 that is coupled to another end of the sub-link arm 21. The connector WC1 of the routed line W that has been routed through the side closer to the main link arm 11 of the first coupler 22 and the second projecting support Bb2 is connected to the vehicle-body-side connector BC that is provided on a side of the vehicle body B. The connector WC2 of the routed line W that has been routed through the side closer to the main link arm 11 of the second coupler 23 is connected to the door-side connector DC that is provided on a side of the door body D. As described above, the routed line W is connected to the vehicle-body-side connector BC in a state where the routed line W has been routed through the side closer to the main link arm 11 of the first coupler 22 and the second projecting support Bb2.

In the wiring harness routing structure 1 configured as described above, the main link arm 11 is rotationally moved by a driving unit (not illustrated) that includes a motor or the like that is provided in the vehicle body B, and therefore the main link arm 11 and the sub-link arm 21 rotationally move relative to each of the vehicle body B and the door body D, and slide the door body D relative to the vehicle body B from a fully closed position to a fully open position, or from the fully open position to the fully closed position along the sliding direction S. Stated another way, the main link arm 11 is rotationally moved by the driving unit to rotationally move relative to each of the vehicle body B and the door body D by using, as a rotational movement axis, the rotational movement shaft 121 of the first coupler 12 and the rotational movement shaft 131 of the second coupler 13. At this time, the main link arm 11 is rotationally moved by the driving unit, and therefore the sub-link arm 21 rotationally moves relative to each of the vehicle body B and the door body D by using, as a rotational movement axis, the rotational movement shaft 221 of the first coupler 22 and the rotational movement shaft 231 of the second coupler 23. The routed line W that has been routed along the sub-link arm 21 and is housed in the groove 211c also electrically connects the vehicle-body-side connector BC and the door-side connector DC while the sub-link arm 21 is rotationally moving.

As described above, the wiring harness routing structure 1 according to the embodiment includes the main link arm 11, the sub-link arm 21, and the routed line W. The main link arm 11 includes one end that is rotatably coupled to the vehicle body B by using the first coupler 12, and another end that is rotatably coupled to the door body D by using the second coupler 13, and slidably supports the door body D relative to the vehicle body B, while rotationally moving relative to each of the vehicle body B and the door body D. The sub-link arm 21 is provided on a lower side in the height direction Z of the main link arm 11, and includes one end that is rotatably coupled to the vehicle body B by using the first coupler 22, and another end that is rotatably coupled to the door body D by using the second coupler 23. The sub-link arm 21, together with the main link arm 11, slidably supports the door body D relative to the vehicle body B, while rotationally moving relative to each of the vehicle body B and the door body D. The routed line W is routed and provided along the sub-link arm 21, and connects the vehicle-body-side connector BC and the door-side connector DC. In addition, the routed line W is routed through the side closer to the main link arm 11 of the first coupler 22 that is provided in the sub-link mechanism 20.

Here, a vehicle is provided with an obstacle P, which is a structural object that is essential and is not movable to another place for the sake of a configuration of the vehicle, on a side opposite to the side closer to the main link arm 11 of the first coupler 22 of the sub-link mechanism 20. For example, as this obstacle P, a body wall or the like that forms a tire house is provided, as illustrated in FIG. 5, on a side opposite to the side closer to the main link arm 11 of the first coupler 22 of the sub-link mechanism 20, in a case where the door body D is used as a door for a rear seat. As a wiring harness routing structure in a comparative example, for example, in a case where the routed line W has been routed through the side opposite to the side closer to the main link arm 11 of the first coupler 22, it is requested that a routing space be provided between the first coupler 22 and the obstacle P, and in this case, it is requested that the first coupler 22 be disposed closer to the first coupler 12 of the main link mechanism 10. Therefore, in the wiring harness routing structure in the comparative example, a spacing in the height direction Z between the first coupler 12 of the main link mechanism 10 and the first coupler 22 of the sub-link mechanism 20 decreases, and it is difficult to stably support the door body D. In contrast, in the wiring harness routing structure 1 according to the present embodiment, the routed line W is routed through the side closer to the main link arm 11 of the first coupler 22. Therefore, a spacing in the height direction Z between the first coupler 12 of the main link mechanism 10 and the first coupler 22 of the sub-link mechanism 20 can be increased in comparison with a case where the routed line W is routed through a side opposite to the side closer to the main link arm 11 of the first coupler 22, as described in the comparative example, and thus, the door body D can be stably supported, and the door body D can be stably slid along the sliding direction S. As described above, the wiring harness routing structure 1 can properly route the routed line W between the vehicle body B and the door body D in a state where the stability of the door body D is secured. As described above, in a case where the door body D is used as a door for a rear seat, the obstacle P, such as a body wall that forms a tire house, is provided on a side opposite to the side closer to the main link arm 11 of the first coupler 22 of the sub-link mechanism 20. In addition, it is difficult to secure an excess space between the obstacle P, such as a body wall that forms the tire house, and an edge of the doorway Ba. Therefore, in a case where the routed line W has been routed through a side closer to the obstacle P of the first coupler 22 of the sub-link mechanism 20, it is requested that the first coupler 22 of the sub-link mechanism 20 be disposed closer to the first coupler 12 of the main link mechanism 10, because the obstacle P fails to be moved. The wiring harness routing structure 1 according to the present embodiment is effective, in particular, in a case where a routing space is limited for the sake of a structure of the vehicle body B, as described above.

In the wiring harness routing structure 1, the vehicle body B includes the vehicle body frame Bb that forms a framework of the vehicle body B, the first projecting support Bb1 that is provided to project from the vehicle body frame Bb to a vehicle cabin side, and supports the first coupler 12, and the second projecting support Bb2 that is provided to project from the vehicle body frame Bb to the vehicle cabin side, and supports the first coupler 22. The routed line W is routed through a side closer to the main link arm 11 of the second projecting support Bb2. By employing this configuration, in the wiring harness routing structure 1, a spacing in the height direction Z between the first projecting support Bb1 of the vehicle body B and the second projecting support Bb2 of the vehicle body B can be increased, and therefore the main link mechanism 10 and the sub-link mechanism 20 can be mounted on the vehicle body B in such a way that the door body D can be stably supported.

In the wiring harness routing structure 1, the sub-link arm 21 includes the groove 211c that is formed in a groove shape along the extending direction X in which the sub-link arm 21 extends, and can house the routed line W. The routed line W is routed in a state where the routed line W is housed in the groove 211c. By employing this configuration, the wiring harness routing structure 1 can secure a routing space where the routed line W is routed, between the vehicle body B and the door body D, by using the groove 211c of the sub-link arm 21. Furthermore, in the wiring harness routing structure 1, the routed line W that is routed between the vehicle body B and the door body D is housed in the groove 211c of the sub-link arm 21, and is routed. Therefore, the routed line W can be prevented from being exposed to the outside, and can be prevented from being caught in comparison with a case where the routed line W is exposed to the outside, as is conventional. Furthermore, the wiring harness routing structure 1 can hide the routed line W from the outside, and can improve appearance. As described above, the wiring harness routing structure 1 can properly route the routed line W between the vehicle body B and the door body D.

The link type sliding door SD includes the door body D that is mounted on the vehicle body B, the main link arm 11, the sub-link arm 21, and the routed line W, and the routed line W is routed through the side closer to the main link arm 11 of the first coupler 22. By employing this configuration, in the link type sliding door SD, a spacing in the height direction Z between the first coupler 12 of the main link mechanism 10 and the first coupler 22 of the sub-link mechanism 20 can be increased, and therefore the door body D can be stably supported, and the door body D can be stably slid along the sliding direction S. This can achieve a sliding door in which the routed line W has been properly routed between the vehicle body B and the door body D in a state where the stability of the door body D has been secured.

The wiring harness WH includes the routed line W that connects the vehicle-body-side connector BC and the door-side connector DC, and the routed line W is routed through the side closer to the main link arm 11 of the first coupler 22. By employing this configuration, the wiring harness WH can increase a spacing in the height direction Z between the first coupler 12 of the main link mechanism 10 and the first coupler 22 of the sub-link mechanism 20, and therefore the main link mechanism 10 and the sub-link mechanism 20 can stably support the door body D. As a result of this, the routed line W can be properly routed between the vehicle body B and the door body D in a state where the stability of the door body D has been secured.

Variations

An example where the routed line W is routed through the side closer to the main link arm 11 of the second projecting support Bb2 of the vehicle body B has been described, but this is not restrictive. For example, the routed line W may be routed through a side opposite to the side closer to the main link arm 11 of the second projecting support Bb2.

An example where the door body D is mounted on the vehicle body B as a door for a rear seat has been described, but this is not restrictive. For example, the door body D may be mounted on the vehicle body B as another door such as a door for a driver seat or a passenger seat.

An example where in the wiring harness routing structure 1, the main link arm 11 is rotationally moved by the driving unit so that the main link arm 11 and the sub-link arm 21 rotationally move relative to each of the vehicle body B and the door body D has been described, but this is not restrictive. For example, the driving unit may be omitted, and the main link arm 11 and the sub-link arm 21 may rotationally move relative to each of the vehicle body B and the door body D according to an operation performed by an occupant of a vehicle to slide the door body D.

An example where the groove 211c is formed to have a rectangular cross section has been described, but this is not restrictive. For example, the cross section may be formed in a U-shape in which a bottom face is curved, a C-shape, an H-shape, or the like.

An example where in the groove 211c, the bottom face 211a is located on one side (a side opposite to the door body D) in the width direction Y, and another side (a side of the door body D) in the width direction Y of the bottom face 211a is open has been described, but this is not restrictive. For example, the bottom face 211a may be located on one side (for example, an upper side) in the height direction Z, and another side (for example, a lower side) in the height direction Z of the bottom face 211a may be open. In this case, the pair of side walls 211b are provided on body sides in the width direction Y of the bottom face 211a.

An example where the main link arm 11 rotationally moves by using, as a rotational movement axis, the rotational movement shafts 121 and 131 at both ends in a single arm member has been described, but this is not restrictive. For example, a configuration where the main link arm 11 is divided in the extending direction X, and restrictive divided arms are connected by a link may be employed.

An example where the sub-link arm 21 rotationally moves by using, as a rotational movement axis, the rotational movement shafts 221 and 231 at both ends in a single arm member has been described, but this is not restrictive. For example, a configuration where the sub-link arm 21 is divided in the extending direction X, and restrictive divided arms are connected by a link may be employed. In this case, the restrictive divided arms may be provided with a groove, restrictive grooves may be continuous over the restrictive divided arms, and the routed line W may be routed in the grooves that are continuous over these respective divided arms.

An example where in the main link mechanism 10, the routed line W is not routed along the main link arm 11 has been described, but this is not restrictive. For example, in a case where the routed line W has been routed along the sub-link arm 21, the routed line may also be separately routed along the main link arm 11.

An example where the main link arm 11 is firmed in a pole shape has been described, but this is not restrictive. For example, the main link arm 11 may be formed in a shape including a groove, and the routed line W may be housed in the groove. Furthermore, the main link arm 11 may be formed in a tube shape, and the routed line W may be inserted into an inside, and may be routed.

An example where the sub-link arm 21 includes the groove 211c has been described, but this is not restrictive. The groove 211c may be omitted. In this case, the sub-link arm 21 is formed, for example, in a tube shape, a bar shape (a pole shape), or the like. In a case where the sub-link arm 21 is formed in the tube shape, the routed line W is inserted into an inside and is routed. In a case where the sub-link arm 21 is formed in the bar shape (the pole shape), the routed line W is routed to be aligned with the arm.

In the wiring harness routing structure, the link type sliding door, and the wiring harness according to the present embodiment, the routed line is routed through a side closer to the first link arm of the second vehicle-body-side coupler. Therefore, for example, in comparison with a case where the routed line is routed through a side opposite to the side closer to the first link arm of the second vehicle-body-side coupler, a spacing in the vertical direction between the first vehicle-body-side coupler and the second vehicle-body-side coupler can be increased. Thus, the door body is stably supported, and as a result of this, the routed line can be properly routed between the vehicle body and the door body.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wiring harness routing structure comprising:
a first link arm that includes one end that is rotatably coupled to a vehicle body by using a first vehicle-body-side coupler, and another end that is rotatably coupled to a door body by using a first door-side coupler, the first link arm slidably supporting the door body relative to the vehicle body, while rotationally moving relative to each of the vehicle body and the door body;
a second link arm that is provided on a lower side in a vertical direction of the first link arm, and includes one end that is rotatably coupled to the vehicle body by using a second vehicle-body-side coupler, and another end that is rotatably coupled to the door body by using a second door-side coupler, the second link arm, together with the first link arm, slidably supporting the door body relative to the vehicle body, while rotationally moving relative to each of the vehicle body and the door body; and
a routed line that is routed and provided along the second link arm, and connects a connection target on a side of the vehicle body and a connection target on a side of the door body, wherein
the routed line is routed through a side closer to the first link arm of the second vehicle-body-side coupler.

2. The wiring harness routing structure according to claim 1, wherein
the vehicle body includes a vehicle body frame that forms a framework of the vehicle body, a first projecting support that is provided to project from the vehicle body frame to a vehicle cabin side, and supports the first vehicle-body-side coupler, and a second projecting support that is provided to project from the vehicle body frame to the vehicle cabin side, and supports the second vehicle-body-side coupler, and
the routed line is routed through the side closer to the first link arm of the second projecting support.

3. The wiring harness routing structure according to claim 1, wherein
the second link arm includes a groove which is formed in a groove shape along an extending direction in which the second link arm extends, and enables the routed line to be housed, and
the routed line is routed in a state where the routed line is housed in the groove.

4. The wiring harness routing structure according to claim 2, wherein
the second link arm includes a groove which is formed in a groove shape along an extending direction in which the second link arm extends, and enables the routed line to be housed, and
the routed line is routed in a state where the routed line is housed in the groove.

5. A link type sliding door comprising:
a door body that is mounted on a vehicle body;
a first link arm that includes one end that is rotatably coupled to the vehicle body by using a first vehicle-body-side coupler, and another end that is rotatably coupled to the door body by using a first door-side coupler, the first link arm slidably supporting the door body relative to the vehicle body, while rotationally moving relative to each of the vehicle body and the door body;
a second link arm that is provided on a lower side in a vertical direction of the first link arm, and includes one end that is rotatably coupled to the vehicle body by using a second vehicle-body-side coupler, and another end that is rotatably coupled to the door body by using a second door-side coupler, the second link arm, together with the first link arm, slidably supporting the door body relative to the vehicle body, while rotationally moving relative to each of the vehicle body and the door body; and
a routed line that is routed and provided along the second link arm, and connects a connection target on a side of the vehicle body and a connection target on a side of the door body, wherein
the routed line is routed through a side closer to the first link arm of the second vehicle-body-side coupler.

6. A wiring harness comprising:
a routed line that is routed and provided along a second link arm, and connects a connection target on a side of a vehicle body and a connection target on a side of a door body, the second link arm being provided on a lower side in a vertical direction of a first link arm, and including one end that is rotatably coupled to the vehicle body by using a second vehicle-body-side coupler, and another end that is rotatably coupled to the door body by using a second door-side coupler, the second link arm, together with the first link arm, slidably supporting the door body relative to the vehicle body, while rotationally moving relative to each of the vehicle body and the door body, the first link arm including one end that is rotatably coupled to the vehicle body by using a first vehicle-body-side coupler, and another end that is rotatably coupled to the door body by using a first door-side coupler, the first link arm slidably supporting the door body relative to the vehicle body, while rotationally moving relative to each of the vehicle body and the door body, wherein
the routed line is routed through a side closer to the first link arm of the second vehicle-body-side coupler.
